(19) United States
(12) Patent Application Publication
(10) Pub. No.: US 2014/0124719 A1
(43) Pub. Date: May 8, 2014

(54) Horizontal Drum Winch

(71) Applicant: TRINITY INDUSTRIES, INC., Dallas, TX (US)

(72) Inventor: Emrey Zachariah Wiley, Gallatin, TN (US)

(73) Assignee: Trinity Industries, Inc., Dallas, TX (US)

(21) Appl. No.: 13/665,612

(22) Filed: Nov. 5, 2012

(51) Int. Cl. B66D 1/34; B66D 1/02

(52) U.S. Cl. 254/342; 254/266

(57) ABSTRACT

According to some embodiments, a winch apparatus comprises a winch housing and a winch drum rotationally mounted to the housing. The winch drum is configured to rotate around its vertical axis. The winch drum comprises a slotted keyhole for coupling a winch line to the winch drum. The slotted keyhole comprises an opening at a first end configured to receive the winch line positioned in the slotted keyhole and an opening at a second end configured to retain the winch line. A longitudinal axis of the slotted keyhole is offset from horizontal.

### TECHNICAL FIELD OF THE INVENTION

This disclosure generally relates to winches, and more particularly to a horizontal drum winch.

### BACKGROUND

Winches for tensioning and paying out wire line or rope are well known in the marine industry. Deck hands use manual or powered winches to assist with tasks such a loading or unloading cargo or connecting two vessels together. Marine vessels may also maintain their position in relation to a mooring structure such as a dock by using winches.

The barge transportation industry uses winches to connect barges to each other in a barge tow and to connect the barge tow to a tow vessel. Each barge typically has two or four deck mounted winches. A deck hand connects the winch line to a deck fitting on an adjacent barge and then winches the line tight, connecting the barges together. To disassemble the barge tow, the deck hand releases tension on the winch and pays out the line. A tow vessel typically connects to the rear of the barge tow in a similar manner. During transportation, deck hands may need to disassemble and reassemble the barge tow to pass through locks or navigate constricted waterways. Deck mounted winches may also secure a barge to a dock during loading or unloading operations.

### SUMMARY OF THE INVENTION

In accordance with particular embodiments of the present disclosure, a winch apparatus comprises a winch housing and a winch drum rotationally mounted to the housing. The winch drum is configured to rotate around its vertical axis. The winch drum comprises a slotted keyhole for coupling a winch line to the winch drum. The slotted keyhole comprises an opening at a first end configured to receive the winch line positioned in the slotted keyhole and an opening at a second end configured to retain the winch line. A longitudinal axis of the slotted keyhole is offset from horizontal.

The winch apparatus may comprise a drive mechanism coupled to the winch drum for rotating the winch drum. The drive mechanism may include a ring coupled to the winch drum with one or more protrusions providing grip for rotating the drive mechanism.

In accordance with particular embodiments, a method for using a winch apparatus includes coupling a winch line to a slotted keyhole of a winch drum rotationally mounted to a winch housing. A longitudinal axis of the slotted keyhole is offset from horizontal. The slotted keyhole comprises an opening at a first end of the slotted keyhole configured to receive the winch line positioned in the slotted keyhole and an opening at a second end of the slotted keyhole configured to retain the winch line positioned in the slotted keyhole.

Certain embodiments may provide one or more technical advantages. In some embodiments, the horizontal configuration of a winch apparatus provides efficient use of deck space and a low profile design less inclined to interfere with operations on deck. Winch line may be stored within the winch housing providing further conservation of deck space. Storing the winch line horizontally around the winch drum allows for simple transitioning from a stowed condition to a tensioned condition. The slotted keyhole provides a time savings when securing winch line to the winch drum. Additionally, securing winch line with the slotted keyhole avoids extra wraps of winch line which also decreases the length of winch line. In additional embodiments, the low profile ring coupled to the winch drum minimizes interference with deck operations, which is a common problem with traditional winch designs. Deckhands operate a winch to assemble and disassemble a barge tow many times during a voyage. Any efficiencies in winch design result in cost savings for the barge operator.

As a result, particular embodiments of the present disclosure may provide numerous technical advantages. Particular embodiments the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1A is an overhead view of an example barge tow where the barges are connected to each other and a tug vessel by multiple winches and winch line;

FIG. 1B is a perspective view of the deck of one of the barges in FIG. 1A;

FIGS. 2A-2C illustrate a perspective and two side schematics of a winch assembly, in accordance with particular embodiments;

FIGS. 3A-3B illustrate a perspective and side schematic of a winch drum assembly, in accordance with particular embodiments;

FIG. 4A illustrates a winch assembly with a winch line under tension, in accordance with particular embodiments;

FIG. 4B illustrates a winch assembly with a winch line stored in the housing, in accordance with particular embodiments; and

FIG. 5 further illustrates interaction between a winch line and a slotted keyhole of a winch drum, in accordance with particular embodiments.

### DETAILED DESCRIPTION

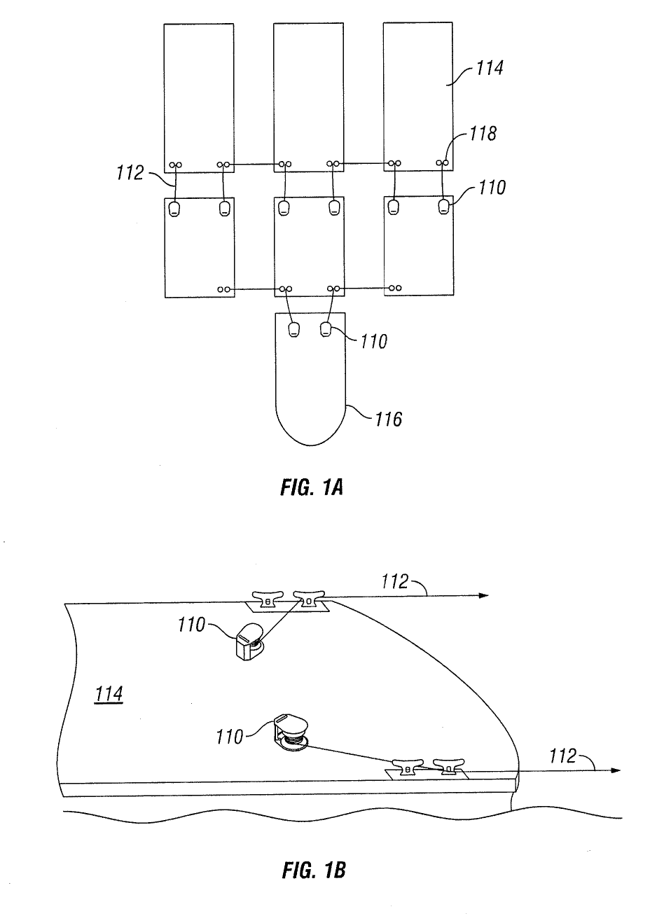

Particular embodiments of the invention and its advantages are best understood by reference to FIGS. 1 through 5 wherein like reference numbers indicate like features.

A goal of the barge transportation industry is to maximize the usage of available barge deck space. Existing vertically mounted winches do not optimize the use of deck space. Vertically mounted winches protrude above the deck surface where they become obstacles during the loading or unloading of cargo. Typically large hand wheels operate the winch drive mechanism. These hand wheels further consume deck space and are obstacles during normal deck operations.

In addition to physically consuming more space, vertically mounted winch assemblies waste deck space by not efficiently storing slack winch line. A typical vertically mounted winch assembly has a winch drum approximately ten inches in diameter wound with one inch wire rope. The stiffness of one inch wire rope will cause it to unwind from a 10 inch diameter winch drum when the wire rope is not under tension. Unwinding of the wire rope can lead to tangles. To prevent tangling, deck hands store the slack wire rope on the deck, which consumes additional deck space.

Minimizing the length of winch line required for operation also leads to increased efficiencies. Conventional vertically mounted winches typically require a certain number of wraps around the winch drum to keep the winch line secured during operation. The extra wraps increase the length of the winch line which increases the storage space needed. The extra wraps also increase the time for a deck hand to secure or unsecure the winch line from the winch drum.

FIG. 1A illustrates an overhead view of an example barge tow where barges are connected to each other and a tug vessel by multiple winches and winch line. One or more winches 110 are mounted to the deck of barge 114. Winch line 112 couples winch 110 mounted on barge 114 to mounting point 118 on adjacent barge 114. A deckhand secures barges 114 together by tensioning winch line 112 with winch 110. A deckhand separates barges 114 by releasing tension on winch line 112. Winch line 112 may comprise wire rope, nylon rope, cotton rope, a synthetic strap, chain, or any coupling material with the appropriate tensile strength for a particular embodiment.

One or more winches 110 may also be mounted to the deck of tug vessel 116. Winch line 112 couples winch 110 mounted on tug vessel 116 to mounting point 118 on adjacent barge 114. A deckhand secures tug vessel 116 to adjacent barge 114 by tensioning winch line 112 with winch 110. A deckhand separates tug vessel 116 from adjacent barge 114 by releasing tension on winch line 112. In another embodiment, mounting point 118 may be located on tug vessel 116, and winch 110 may be located on barge 114. Tug vessel 116 tows the collection of barges 114 from a source along a waterway to a destination.

FIG. 1B illustrates a perspective view of the deck of the barge in FIG. 1A. This figure shows the horizontal orientation of winch 110 and winch line 112. In other embodiments barge 114 may have winches 110 mounted at any number of locations.

In addition to coupling barge 114 to adjacent barge 114 or tug vessel 116 to adjacent barge 114, winch 110 and winch line 112 may also couple marine vessels to a mooring structure such as a dock. Winch 110 may be mounted either on the dock, the marine vessel, or both. One of skill in the art would contemplate mounting winch 110 on any essentially suitable surface, such as a generally horizontal surface.

Barge 114 may be a simple structure without onboard power. In that environment manual operation of winch 110 is desirable. In other environments where power is available, such as tug vessel 116 or the dock of a commercial shipyard, a motor operated winch 110 may be desirable. One of skill in the art would understand how to adapt a motor to operate winch 110.

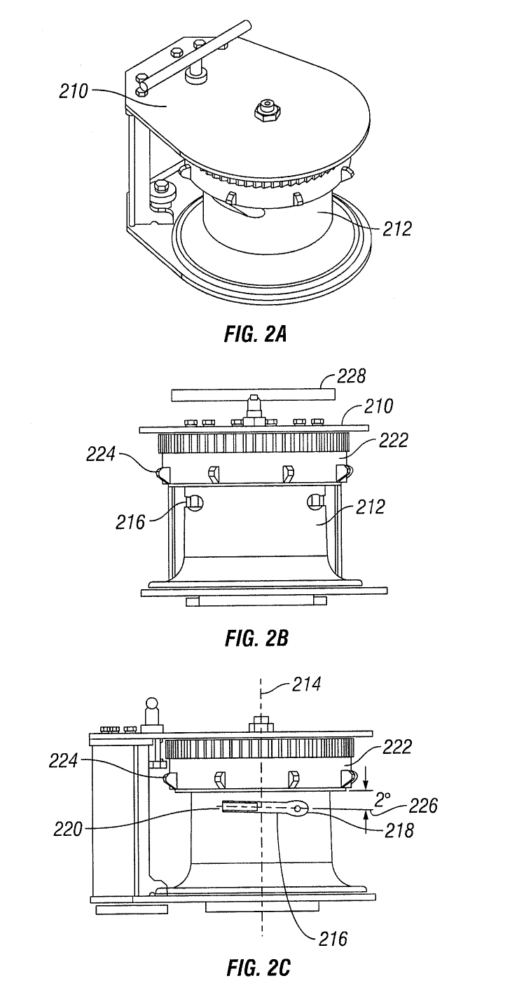

FIGS. 2A-2C illustrate perspective and side schematics of a winch housing and a winch drum, in accordance with particular embodiments. Winch drum 212 is rotationally mounted to winch housing 210. Winch drum 212 rotates around vertical axis 214. Winch drum 212 contains at least one slotted keyhole 216. Slotted keyhole 216 comprises first end 218 configured to receive winch line 112 and second end 220 configured to retain winch line 112.

One benefit of slotted keyhole 216 is that it secures winch line 112 to winch drum 212 without additional wraps of winch line 112 around winch drum 212. The end of winch line 112 slides into first end 218 of slotted keyhole 216. Tension on winch line 112 pulls the end of winch line 112 towards second end 220 of slotted keyhole 216. Second end 220 is configured to prevent winch line 112 from sliding through or out of slotted keyhole 216. Thus slotted keyhole 216 secures winch line 112 to winch drum 212 without the aid of additional friction provided by extra wraps of winch line 112 around winch drum 221.

Another benefit is that a deckhand can quickly insert or remove winch line 112 from slotted keyhole 216. With a conventional winch, a deck hand may have to attach a winch line to the winch drum with a U-bolt and then wrap the winch line around the winch drum several times. The deck hand may have to use a wrench or ratchet tool to secure the U-bolt. The deck hand may first have to retrieve the tool from a tool storage location. The deck hand would reverse the steps to remove the winch line. Slotted keyhole 216 allows a deckhand to quickly secure winch line 110 by inserting the end of winch line 112 into first end 218. A deckhand removes winch line 112 from slotted keyhole 216 by releasing tension on winch line 110 and reversing winch line 110 back out of first end 218. Other embodiments may use slots of different shapes to secure winch line 112 to winch drum 212.

Slotted keyhole 216 includes a longitudinal axis 226 that is generally oriented in the same direction that winch line 112 pays out from winch drum 212. Longitudinal axis 226 is slightly offset from horizontal. In one embodiment, longitudinal axis 226 is offset at least approximately two degrees from horizontal. The offset allows winch line 112 to neatly spool around winch drum 212 when winch line 112 is under tension. Without the offset, winch line 112 may tend to pile on itself around winch drum 212 which would lead to tangling and increased wear on winch line 112. Other embodiments that use different shaped slots may vary an offset angle accordingly.

A geared drive mechanism (not illustrated) coupled to winch drum 212 rotates winch drum 212. The drive mechanism may be located within winch drum 212, on the surface of winch drum 212, or any location suitable for applying rotational force to the winch drum. Conventional winches use a large hand wheel or bar shaped handle to turn the drive mechanism. These methods for turning the drive mechanism take up space on deck and present obstacles to efficient deck operations. In one embodiment ring 222 is coupled to the geared drive mechanism. Ring 222 has a plurality of protrusions 224 allowing a deck hand to grip ring 222 while applying rotational force. Rotation of ring 222 causes rotation of winch drum 212. The particular size and configuration of gears coupling ring 222, the drive mechanism, and winch drum 212 will determine the amount of force required to rotate winch drum 212. The low profile design of ring 222 and protrusions 224 will minimize interference with deck operations.

Other embodiments contemplate ring 222 functioning as the primary tensioning mechanism in conjunction with secondary tensioning mechanism 228. Secondary tensioning mechanism 228 is also coupled to the geared drive mechanism to provide additional tensioning. For example, ring 222 may be coupled through gears that allow easy rotation of winch drum 212 and relatively quick tensioning of winch line 112. Secondary tensioning mechanism 228 may be coupled through gears of a different size that allow for higher tensioning but requires more turns.

A horizontally mounted winch assembly provides a more compact and more efficient winch design. Horizontally mounted winch 110 maintains a low profile by not protruding as high above the deck surface of barge 114. Low profile winch 110 is less of an obstacle to deck operations. Another benefit is that a horizontally mounted winch assembly can contain a larger diameter winch drum 212 in approximately the same footprint as a conventional vertically mounted winch assembly. The larger diameter winch drum 212 allows for storage of slack winch line 112 within winch housing 210 without tangling. Additionally, horizontal storage of winch line 112 around winch drum 212 allows for simple transition from a stowed condition to a tensioned condition of winch line 112. Finally, slotted keyhole 216 for retaining winch line 112 in winch drum 212 requires fewer wraps of winch line 112, allowing for shorter lengths of winch line 112. Slotted keyhole 216 also allows a deckhand to quickly secure or unsecure winch line 110.

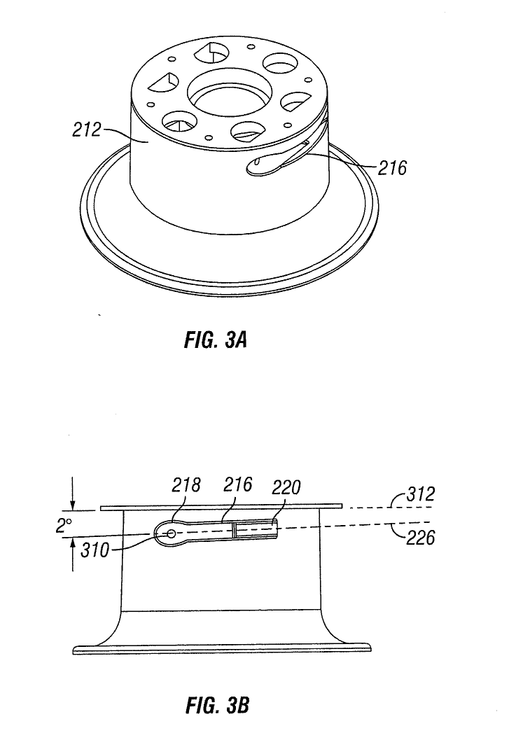

FIGS. 3A and 3B illustrate a perspective and side schematic of a winch drum assembly, in accordance with particular embodiments. The figures highlight the orientation of longitudinal axis 226 of slotted keyhole 216 in relation to horizontal axis 312. Additionally, FIG. 3B highlights opening 310 located in first end 218 of slotted keyhole 216. In one embodiment, opening 310 accepts a fastener configured to retain winch line 112 in slotted keyhole 216 when winch line 112 is not under tension. Tension on winch line 112 holds the end of winch line 112 tight against second end 220 of slotted keyhole 216. When winch line 112 is not under tension, the end of winch line 112 may easily be removed through first end 218. The benefits of efficiently removing winch line 112 from winch drum 212 were discussed above. In other embodiments, a deck hand may find it beneficial for winch line 112 to remain secured to winch drum 212 even when winch line 112 is not under tension. In those embodiments, a deck hand may insert a removable fastener into opening 310 after winch line 112 is secured to winch drum 212. The removable fastener prevents winch line 112 from sliding back through first end 218 even without tension on winch line 112. The deck hand then removes the fastener before unsecuring winch line 112 from winch drum 212. For example, opening 310 could be threaded to accept a socket head cap screw. In other embodiments, opening 310 is configured to accept any removable fastener operable to retain winch line 112 within slotted keyhole 216.

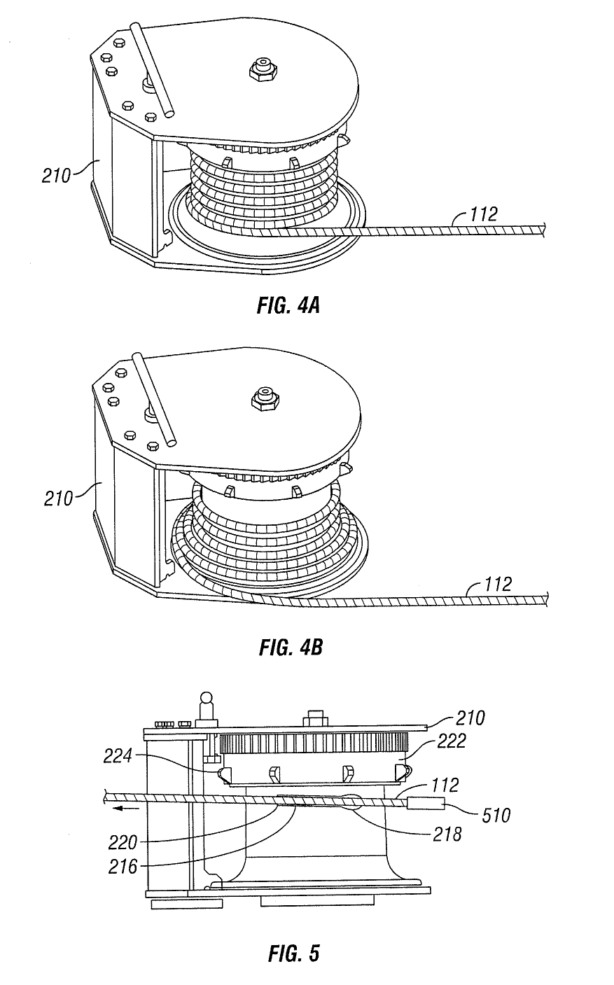

FIG. 4A illustrates a winch assembly with a winch line under tension, in accordance with particular embodiments. Winch line 112 is neatly wrapped around winch drum 212 when winch line 112 is under tension.

FIG. 4B illustrates a winch assembly with a winch line stored within the winch housing when the winch line is not under tension, in accordance with particular embodiments. Because of its horizontal configuration, winch drum 212 can have a diameter of approximately eighteen inches without interfering with deck operations. The larger diameter allows winch line 112 to remain coiled within winch housing 210 when not under tension. Storing winch line 112 within winch housing 210 keeps winch line 112 off the deck of barge 114 and out of the way of deck operations.

FIG. 5 further illustrates the interaction of a winch line and a slotted keyhole of winch drum, in accordance with particular embodiments. In one embodiment, winch line 112 is terminated with sleeve 510. First end 218 of slotted keyhole 216 is configured to be large enough to accept winch line 112 and sleeve 510. Second end 220 of slotted keyhole 216 is configured so winch line 112 may pass through but sleeve 510 may not. In some embodiments, sleeve 510 may be a swaged button. The shape of line terminating sleeve may vary in accordance with the shape of the slot in winch drum 212. For example, one of skill in the art might consider using a T-shaped line terminating sleeve with a T-shaped slot in winch drum 212.

In other embodiments, other types of methods may be used to couple the winch line to a winch drum. Some such methods may include a keyhole and others may not. In some embodiments winch line 112 may be coupled to winch drum 212 with a fastener mounted to the surface of winch drum 212. For example, a U-bolt may clamp winch line 112 to winch drum 212. Because winch line 112 may be stored within winch housing 110, winch line 112 may be permanently coupled to winch drum 212.

Although embodiments of the present disclosure and their advantages have been described in detail, it should be understood that various changes, substitutions and alternations can be made herein without departing from the spirit and scope of the invention as defined by the following claims.

What is claimed is:

1. A winch apparatus, comprising:
a winch housing;
a winch drum rotationally mounted to the housing and configured to rotate around a vertical axis of the winch drum;
the winch drum comprising a slotted keyhole for coupling a winch line to the winch drum, the slotted keyhole comprising:
an opening at a first end of the slotted keyhole configured to receive the winch line positioned in the slotted keyhole, and
an opening at a second end of the slotted keyhole configured to retain the winch line positioned in the slotted keyhole,
wherein a longitudinal axis of the slotted keyhole is offset from horizontal.

2. The winch apparatus of claim 1, where the first end of the slotted keyhole is oriented at least approximately two degrees below horizontal.

3. The winch apparatus of claim 1, where the winch housing and winch drum are configured to store the winch line around the winch drum when the winch line is not under tension.

4. The winch apparatus of claim 1, further comprising:
a drive mechanism coupled to the winch drum for rotating the winch drum, wherein the drive mechanism includes a ring coupled to the winch drum, the ring having one or more protrusions providing grip for rotating the drive mechanism.

5. The winch apparatus of claim 4, wherein the drive mechanism further includes a secondary tensioning mechanism coupled to the winch drum, the secondary tensioning mechanism operable to rotate the winch drum.

6. The winch apparatus of claim 1, where the first end of the slotted keyhole accepts a removable fastener configured to retain the winch line in the slotted keyhole when the winch line is not under tension.

7. A method for using a winch apparatus, comprising:
coupling a winch line to a slotted keyhole of a winch drum rotationally mounted to a winch housing, wherein a longitudinal axis of the slotted keyhole is offset from horizontal, the slotted keyhole comprising:
an opening at a first end of the slotted keyhole configured to receive the winch line positioned in the slotted keyhole; and
an opening at a second end of the slotted keyhole configured to retain the winch line positioned in the slotted keyhole.

8. The method for using a winch apparatus of claim 7, further comprising:
rotating the winch drum in a first direction around a vertical axis of the winch drum to tension the winch line.

9. The method for using a winch apparatus of claim 7, further comprising:
rotating the winch drum in a second direction around the vertical axis of the winch drum to untension the winch line.

10. The method for using a winch apparatus of claim 7, where the first end of the slotted keyhole is oriented at least two degrees below horizontal.

11. The method for using a winch apparatus of claim 7, where the winch housing and winch drum are configured to store the winch line around the winch drum when the winch line is not under tension.

12. The method for using a winch apparatus of claim 8, where rotating the winch drum comprises rotating a ring coupled to the winch drum, the ring having one or more protrusions providing grip for rotating the winch drum.

13. The method for using a winch apparatus of claim 12, where rotating the winch drum also comprises rotating a secondary tensioning mechanism coupled to the winch drum, the secondary tensioning mechanism operable to rotate the winch drum.

14. A winch apparatus, comprising:
a winch housing;
a winch drum rotationally mounted to the housing and configured to rotate around a vertical axis of the winch drum; and
a fastener configured to couple a winch line to the winch drum.

15. The winch apparatus of claim 14, wherein a longitudinal axis of the winch line is offset from horizontal when coupled to the winch drum.

16. The winch apparatus of claim 15, where the longitudinal axis of the winch line is offset from horizontal by at least approximately two degrees.

17. The winch apparatus of claim 14, where the winch housing and winch drum are configured to store the winch line around the winch drum when the winch line is not under tension.

18. The winch apparatus of claim 14, wherein the fastener configured to couple the winch line to the winch drum is recessed into the winch drum.

19. The winch apparatus of claim 14, further comprising:
a drive mechanism coupled to the winch drum for rotating the winch drum, wherein the drive mechanism includes a ring coupled to the winch drum, the ring having one or more protrusions providing grip for rotating the drive mechanism.

20. The winch apparatus of claim 19, wherein the drive mechanism further includes a secondary tensioning mechanism coupled to the winch drum, the secondary tensioning mechanism operable to rotate the winch drum.
